(19) United States
(12) Patent Application Publication
(10) Pub. No.: US 2008/0307930 A1
(43) Pub. Date: Dec. 18, 2008

(54) Wrap around tong and method

(76) Inventors: Jon A. Veverica, Katy, TX (US); Jean P. Buytaert, Mineral Wells, TX (US)

Correspondence Address: THE MATTHEWS FIRM, 2000 BERING DRIVE, SUITE 700, HOUSTON, TX, 77057, US

(21) Appl. No.: 11/820,498

(22) Filed: Jun. 18, 2007

(51) Int. Cl. B25B 13/50; B25B 23/00

(52) U.S. Cl. 81/57.34; 81/57.15

(57) ABSTRACT

A wrap around tong system is provided with a rotary drive tong and backup tong that remain positioned around the pipe string as the pipe string is run into or out of the wellbore. The tong system is affixed to the drill floor and does not rotate or move laterally to the pipe string. The power tong system is moved upwardly and downwardly to position the rotary drive tong and backup tong at appropriate postions on the pipe string. The rotary drive tong provides both spinning and torquing for making or breaking connnections.

### BACKGROUND OF THE INVENTION

1. Field of the Invention

The present invention relates generally to power tongs and, more specifically, to power tongs that may be used for making and breaking connections in oil well tubular strings such as drill pipe and casing.

2. Description of the Prior Art

Power tongs have been used for many years for making and breaking tubular connections. However, as power tong systems have become larger and heavier so as to include back-up grips, spinners, and other valuable features that reduce time and improve reliability of the made up tubular connections, it has become necessary to build tracks and the like to control movement of the power tongs on the rig floor. The large size of and heavy weight of modern power tongs makes cable supports a less desirable means of supporting such systems. Movement of large heavy power tong systems either laterally or rotationally produces logistics problems on the rig floor and increases the likelihood of accidents.

Representative patents and publications seeking to solve such problems and related issues include the following:

U.S. Pat. No. 4,492,134, issued Jan. 8, 1985, to Reinholdt et al., discloses a power tongs for threadedly connecting together pipes which are to constitute casings for boreholes, which has a platform for a reciprocable slide which supports a power-driven threading clamp and a counter device. The clamp and the counter device are connected to each other by several level compensating hydraulic cylinders each of which is movable horizontally within limits relative to the slide against the opposition of resilient support elements. The upper end portions of the cylinders are connected to a holding plate for the clamp.

U.S. Pat. No. 4,082,017, issued Apr. 4, 1978, to Emery Eckel, discloses a hydraulically or pneumatically powered drill pipe tongs of the scissors-type used in making up or breaking apart joints of drill pipe, drill collars, and the like including an upper tong and a lower tong each including tong die heads for biting into or gripping the upper and lower joints of drill pipe, drill collars and the like with the upper and lower tongs being swivel connected and being swiveled by a hydraulically or pneumatically powered torqueing piston and cylinder assembly for rotating the upper and lower tongs in relation to each other when making up or breaking apart the drill pipe joints. Each of the upper and lower tongs includes a sliding door having one of the tong die heads thereon that can be moved a substantial distance toward and away from the tong body by the use of a pair of hydraulically or pneumatically powered piston and cylinder assemblies to enable tool joints, drill pipe protectors and the like to pass through the tongs while leaving the tongs on the pipe. Each of the tongs also includes a hinged mounting for one edge portion of the tong door and a latch for the other edge portion to enable the tong door to be latched or unlatched and swung outwardly in a manner to enable the tongs to be removed from the drill pipe when necessary.

U.S. Pat. No. 5,081,888, issued Jan. 21, 1992, to Joerg E. Schulze-Beckinghausen, discloses an apparatus for connecting and disconnecting threaded members including a power tong, a backup unit disposed below the power tong for tripping a second pipe, and apparatus for transmitting reaction forces generated by the power tong to the backup unit, the backup unit having devices for transmitting compressive or tensile forces between its members from the power tong which, in one embodiment, includes a hydraulic connection between a double acting hydraulic piston and cylinder assemblies incorporated in the members.

U.S. Pat. No. 6,138,776, issued Oct. 31, 2000, to Hart et al., discloses a pipe handling system comprising a rig floor supported frame adapted to be positioned above the rotary table and in alignment with the hole in the rotary table. It incorporates a centrally located bowl lined with the frame to enable a string of pipe to extend through the rotary table. Appropriate releasable slips are moved into and out engagement. The frame supports an overhead mounting plate, and one version thereof incorporates hydraulic jacks to raise and lower the mounting plate. The mounting plate supports a horizontally directed hydraulic ram which moves the two end lengths of a long multi length chain looped into a bight to go around a pipe passing near the end of the mounting plate. The bight in the chain grips the coupling of the pipe to hold it fast. This mechanism cooperated with an overhead power tong assembly to enable threading or unthreading of pipe casing and tubing.

U.S. Pat. No. 4,515,045, issued May 7, 1985, to Gnatchenko et al., discloses an automatic wrench comprising a high-torque, a low-torque, and a locking device. The wrench control system includes a torque detector and a rotation angle detector, in response to whose signals passing through an AND gate a control unit delivers a command to end the thread tightening by the rotation actuator of the high-torque device in screwing a pipe string together or to end the initial loosening of the thread with the aid of the same actuator in screwing it apart. The control unit incorporates a unit for monitoring the duration of the command execution, which stops operation of the high-torque device if no signal comes from said AND gate during the time allotted to accomplish the tightening or the initial loosening of the thread.

U.S. Pat. No. 5,271,298, issued Dec. 21, 1993, to Gilles Gazel-Anthoine, discloses a machine for screwing and unscrewing two rods, comprising an annular carcass forming a frame about a central axis and, staggered in height on the carcass, upper and lower wrenches each adapted to grip two successive rods. One of the wrenches, referred to hereinafter as the rotary drive wrench, is mounted rotatably relative to the carcass and the rotary drive wrench at least comprises a plurality of cams distributed circumferenfially and each mounted to pivot about an axis parallel to the central axis between a retracted position in which they leave around the central axis a space sufficient for the rods to pass through and a deployed position in which they intrude on the space and are able conjointly to grip a rod present in the latter. The machine is useful in drilling installations.

U.S. Pat. No. 6,142,041, issued Nov. 7, 2000, to David A. Buck, discloses a power tong positioning apparatus, including a power tong support positionable on the surface of drilling rig deck and attachable to at least one power tong. The power tong support is adapted to position at least one power tong so that it may engage the tubular member. The power tong positioning apparatus a frame, a base moveably positioned on the frame, at least one arm pivotally attached to the base, a power tong support pivotally attached to the arm(s) and movably attachable to at least one power tong.

U.S. Pat. No. 6,142,040, issued Nov. 7, 2000, to Vernon J. Bouligny, discloses a spider, preferably a flush mounted spider, and powered lead tong which are coupled by a rotationally rigid structure so that torque reaction forces apply no side load to pipe. The tong preferably tilts upward to clear larger objects approaching the spider. An optional grabber is mounted, preferably atop the lead tong, and may tilt with the lead tong. Fluid powered motors, linear or rotary, provide the tilting energy and extend and retract the grabber. The tong and related structure has quick coupler provisions for removal from the spider.

Farrcanada provides a tong assembly on a track that moves along a track to engage the tubular connections as shown at website www.farrcanada.com.

The above power tong systems show tongs that either move laterally with respect to the pipe and/or have outer housings that rotate around the pipe and/or do not include a complete power tong assembly capable of spinning, backing up, applying torque, automatic slips, and the like. Consequently, it would be desirable to provide a system and method that is designed to avoid lateral and rotational movement of large power tong housings and provide virtually all functions required at the rig floor for making and breaking connections of either drill pipe or casing. Those skilled in the art will appreciate the present invention that addresses the above and other needs and problems.

### SUMMARY OF THE INVENTION

Accordingly, it is an object of the present invention to provide an improved power tong system and method.

It is yet another object of the present invention to provide an improved system and method for performing making and breaking functions at the rig floor with improved safety features.

It is yet another object of the present invention to provide an improved system that provides virtually all functions of making and breaking pipes at the rig floor without the need for movement of large housings either laterally or rotationally around the pipe.

These and other objects, features, and advantages of the present invention will become apparent from the drawings, the descriptions given herein, and the appended claims.

Therefore, in accordance with the present invention, an apparatus is disclosed for a power tong system for making and breaking connections in a tubular string. The power tong system may be used on a rig floor and comprises one or more elements such as a power tong housing, and at least one rotary drive tong mounted within the power tong housing for encircling and gripping a first portion of the tubular string. The rotary drive tong preferably has a rotatable gear therein for applying rotational force to the first portion of the tubular string. Other elements may include at least one backup tong having gripping elements therein for holding a second portion of the tubular string while the rotary drive tong applies the rotational force to the first portion of the tubular string. A plurality of lift assemblies may each include slidable shafts for moving the power tong housing upwardly and downwardly. The plurality of lift assemblies may be secured with respect to the rig floor such that the power tong housing is moveable upwardly and downwardly with respect to the rig floor and such that the power tong housing is prevented from rotating with respect to the rig floor.

Preferably the system includes powered slips operable for powered movement of slips into and out of gripping engagement with the tubular string. The powered slips are operable for supporting a weight of the tubular string.

In one embodiment, a collar locator produces a collar locator signal in response to at least one of the connections in the tubular string. A tong control is responsive to the collar locator signal for automatically controlling the upwardly or downwardly movement of the power tong housing for positioning the rotary drive tong and the backup tong with respect to one of the connections.

As an added feature of the invention, either the collar locator itself, or a separate detector, for example, a magnetic flux detector, can be used as an inspection device to locate cracks, holes, leaks and other anomalies in the tubulars being made up or broken out of an oil well tubular string.

A drive gear may be provided within the at least one rotary drive tong which completely encircles the tubular string. A plurality of cams may be mounted to the drive gear for movement therewith. A removable section for the drive gear may be provided such that when removed the drive gear can be laterally moved away from the tubular string.

An expandable connection may be provided between the rotary drive tong and backup tong to permit relative up and down movement therebetween. Moreover, an extension member may be used for connecting between the at least one rotary drive tong and the at least one backup tong to permit the rotary drive tong and the backup tong to both grip either on a respective portion of the connection or simultaneously above and below the connection.

A plurality of piston driven gripping elements may be provided within the backup tong for selectively engaging and disengaging the second portion of the tubular string.

Thus, in one embodiment, the power tong system may comprise at least one rotary drive tong for gripping a first portion of the tubular string having a rotatable gear therein for applying rotational force to the first portion of the tubular string and at least one backup tong having gripping elements therein for holding a second portion of the tubular string while the rotary drive tong applies the rotational force to the first portion of the tubular string. A plurality of lift assemblies move the rotary drive tong upwardly and downwardly with respect to the rig floor. The plurality of lift members may be secured with respect to the rig floor. Powered slips are preferably provided that are operable for powered movement of slips into and out of gripping engagement with the tubular string for supporting a weight of the tubular string as desired. As well, a preferred embodiment includes a collar locator for producing a collar locator signal in response to at least one of the connections in the tubular string, and a control responsive to the collar locator signal for automatically controlling the upwardly or downwardly movement of the plurality of lift members.

The collar locator may be of various types and may include an electronic proximity detector for the collar locator such as circuitry for detecting variations in a magnetic field or circuitry for detecting variations in a transmitted signal.

A method for making or breaking connections in a tubular string as the tubular string is run into or out of a wellbore may comprise steps such as providing a power tong housing with a rotatable drive gear therein such that the power tong housing remains encircling the tubular string as the tubular string is run into or out of the wellbore. Other steps may include securing a back up power tong with respect to the power tong housing and/or moving the rotary drive tong and the back up power tong in a direction substantially parallel with respect to the tubular string. In a preferred embodiment, the method of the invention may comprise steps such as supporting the rotary drive tong to prevent rotation of the power tong housing during the making or breaking of the connections and/or producing an electronic signal in response to locating a connection. The method may further comprise positioning the rotary drive tong and the power tong backup in response with respect to the tubular string in response to the electronic signal.

### BRIEF DESCRIPTION OF THE DRAWINGS

A more complete understanding of the invention and many of the attendant advantages thereto will be readily appreciated as the same becomes better understood by reference to the following detailed description when considered in conjunction with the accompanying drawings wherein corresponding reference characters indicate corresponding parts throughout the drawing and wherein:

FIG. 1 is an elevational view, partially in section, of a power tong system in accord with the present invention with automatic slips in the open position as the elevators raise the pipe string;

FIG. 2 is an elevational view, partially in section, of the embodiment of FIG. 1 in with automatic slips in the closed position to support the pipe string;

FIG. 3 is an elevational view, partially in section, of the embodiment of FIG. 1 wherein a drill pipe collar is automatically located and broken apart;

FIG. 4 is an elevational view of a rotary drive for wrap around power tong with removable gear section in accord with the present invention;

FIG. 5 is an elevational view of a representative cam system for a wrap around power tong in accord with the present invention;

FIG. 6 is an elevational view of a representative back up clamp in accord with the present invention;

FIG. 7A is an elevational view of a representative sliding connection for relative movement of a wrap around tong and back up clamp in an open position in accord with the present invention;

FIG. 7B is an elevational view of a representative sliding connection for relative movement of a wrap around tong and back up clamp in an open position in accord with the present invention;

FIG. 8 is an elevational view, partially in section, showing a power tong system in accord with the present invention having tong and backup above and below a joint of casing for gripping in accord with one embodiment of the invention;

FIG. 9 is a schematic view of a representative magnetic collar locator circuit in accord with the present invention;

FIG. 10 is a schematic view of a representative collar locator circuit utilizing a proximity detector in accord with the present invention;

FIG. 11 is a schematic view of a representative block diagram for a control system in accord with the present invention; and

FIG. 12 is a schematic view of one representative flush-mounted power slips assembly as part of a power tong system in accord with the present invention.

### BRIEF DESCRIPTION OF THE PREFERRED EMBODIMENTS

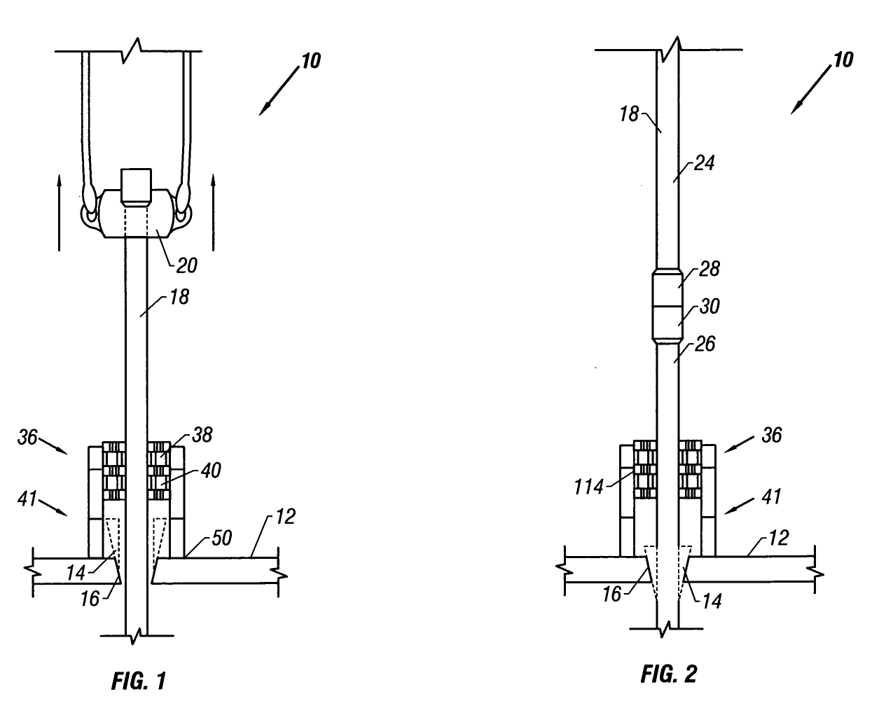

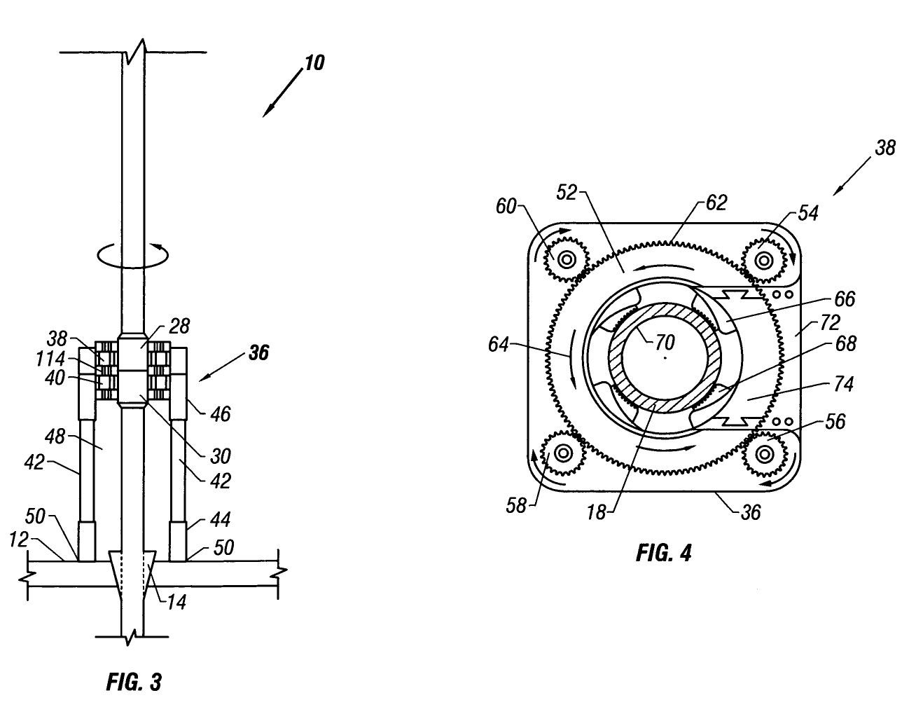

Referring now to the drawings and, more particularly to FIG. 1, FIG. 2, and FIG. 3, there is shown a power tong system 10 in accord with the system of the present invention in different stages of operation. One problem the present invention is designed to eliminate is that of moving a large tong system laterally with respect to the pipe string for each joint to be connected or disconnected. Instead the present invention remains in the same lateral position and preferably does not rotate during operation. The present invention preferably remains wrapped around the drill string as the entire string is built into or removed from the wellbore. To further enhance operation, the present invention preferably incorporates powered slips therewith for improved operation as discussed hereinafter. The present invention preferably utilizes a collar locator for automatic height positioning, and also preferably utilizes an inspective device to locate or otherwise identify cracks, holes, leaks and other anomalies in the tubulars being made up or broken out of an oil well tubular string. Moreover, the tong system of the present invention incorporates a simplified arrangement as discussed hereinafter.

It will be understood that such terms as up, down, vertical, and the like, are made with reference to the drawings and/or the earth and that the inventive devices may not be arranged in such positions at all times depending on variations in operation, transportation, and the like. It will also be understood that the drawings are intended to describe the concepts of the invention so that the presently preferred embodiments of the invention will be plainly disclosed to one of skill in the art but are not intended or required to be manufacturing level drawings or renditions of final products and therefore may include simplified conceptual views as desired for easier and quicker understanding or explanation of the invention. As well, the relative size and relative dimensions of the components may be greatly different from that shown.

FIG. 1 discloses power tong system 10 in a retracted or lowered position with respect to rig floor 12. Power slips 14, shown schematically, are positioned upwardly in bowl 16 and therefore disengaged from tubular string 18 which is now supported by elevators 20. In FIG. 1, elevators 20 are used to lift tubular string 18 upwardly as indicated using rig blocks (not shown) for removing the pipe string from the wellbore. For installing tubular string 18, the process would be the reverse.

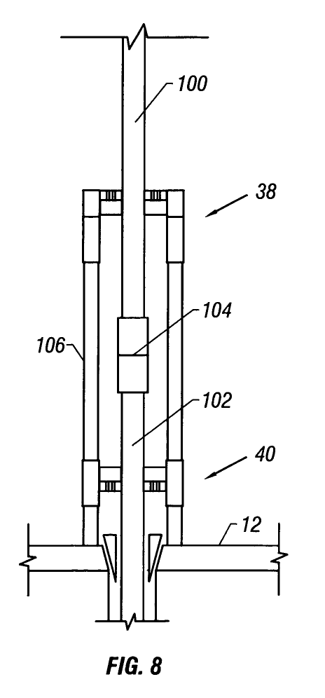

In FIG. 2, as the tubular string is removed the various joints for each stand pass through power tong system 10 until the desired joint to be broken, such as joint 22, is positioned within operating range of tong system 22. Joint 22 is the connection of an upper pipe 24 and a lower pipe 26 with respecting pin connection 28 and box connection 30. For operation of tong system 10 with drill pipe, it may be desirable or required that torque be applied only to the strengthened and enlarged or upset pin connection 28 and box connection 30. For operation of tong system 10 with casing, it may be more desirable or required that torque be applied to the pipe sections rather than the joint as suggested in FIG. 8, discussed hereinafter. Once connection 22 is positioned as desired, the operator engages power slips 14. Thus, an operator uses a control for tong system 10 to insert power slips 14 downwardly in bowl 16 to thereby support the weight of pipe string 18 so that connection 22 can be broken and pipe 24 or the stand to which pipe 24 connected can be removed such as for stacking.

FIG. 12 shows a schematic representation for power slips 34 flush-mounted with respect to rig floor 12 which may use power actuators such as actuators 32 for inserting or removing slips 14 with respect to bowl 16. FIG. 12 is only intended to be representative of power slips and other configurations can be used within tong system 10 of the present invention. One advantage of using power slips is improved safety in that personnel may then avoid having to work adjacent to moving equipment such as the power tongs. Since power tong system 10 does not move laterally from the pipe stand for each connection, automatic or powered slip operation increases safety of operation by reducing the need for personnel to work next to moving equipment.

Referring now to FIG. 3, once joint 22 is positioned and slips 14 are engaged, then power tong housing 36 must be positioned appropriately with respect to joint 22 such that rotary drive 38 and back up 40 are positioned correctly. For instance, with drill pipe it may be required that rotary drive 38 and back up 40 be position on enlarged pin 28 and enlarged box 30 in order to apply torque to connection 22 without damaging the drill pipe.

Since tong system 10 is already positioned correctly laterally, it is only necessary that power tong housing 36 be moved upwardly or downwardly, i.e., axially along pipe string 18 in a direction substantially parallel to pipe string 18 until power tong housing 36 is adjacent connection 22. For this purpose, powered lift assembly 41 is preferably used whereby shafts 42 may preferably be telescopically mounted with respect to cylinders 44 and/or 46. Shafts 42 may therefore extend or retract with respect to cylinders 44 and/or 46. In this manner, powered lifts thereby extend or retract power tong housing 36 so as to locate power tong housing 36 adjacent connection 22. Power for powered lift assembly 41 may include hydraulic, pneumatic, or electric power. Other means for operating powered lifts or constructions of powered lift assembly 41 could also be used. For instance, a screw drive might be used. A single cylindrical powered lift might be used whereby the cylinder surrounds pipe 18. However regardless of construction thereof, preferably openings such as opening 48 are provided for power lift assembly 41, so that power tong system 10 can be moved laterally with respect to pipe string 18, if and when necessary.

Preferably powered lift assembly 41 is securely fastened with respect to rig floor 12. In many cases, rig floor 12 will often have standard openings therein that can be used for this purpose. If cross bars or supports are used between shafts 42, then one portion of the cross bars or shaft would then preferably be removable. Thus, foot elements 50 are preferably fixably secured to rig floor 12 to prevent any movement of foot elements 50 with respect to rig floor 12. Some slight movement or preferably adjustments, usually less than one inch, may be made as necessary to centralize pipe string 18 with respect to the power tongs with adjustment elements located at a convenient position of tong system 10. Thus, rotational movement of power tong system 10 is preferably substantially or completely prevented so as to avoid the safety problem of having large equipment rotate. Moreover, the secure fastening permits secure upward and downward movement of power tong housing 36 with respect to rig floor 12 without permitting rotational movement of power tong housing 36.

FIG. 4 shows a view of rotary drive 38 which may be used for applying rotational force to pipe string 18. Rotary drive 38 preferably includes drive gear 52 that may be driven preferably by several rotary drives such as 54, 56, 58, and 60 positioned around the circumference of drive gear 52 such that forces within drive gear 52 are substantially distributed around the circumference thereof. Use of multiple rotary drives therefore increases the life and durability 10 of rotary drive 38. Thus, teeth on rotary drives 54-60 engage outer teeth 62 for rotating drive gear 52 within power tong housing 36.

As an example of operation, as drive gear 52 rotates as shown by arrow 64, then cams 66 wedge slips 68 radially inwardly to thereby force grips 70 to engage and thereby grip pipe string 18 for applying rotational force thereto. The use of a ring gear, such as drive gear 59 that completely encircles pipe string 18 is desirable to distribute forces and provide a longer lasting system. However, a ring gear that completely encircles pipe string 18 would prevent tong system 10 from the capability of moving laterally for removal of the system, if desired. While tong system 10 could also be moved either by lowering the pipe below ring gear 59 or by lifting tong system 10, it may be desirable to permit lateral movement thereof. For this purpose, housing 36 preferably includes an opening, which may comprise removable housing section 72. Also, in one preferred embodiment drive gear 52 includes removable gear section 74. Thus, upon removing removable gear section 74, and removable housing section 72, then tong system 10 can be laterally moved with respect to pipe string 18 when desired or necessary.

Rotary drive 38 preferably provides all rotating functions including spinning and torqueing. Preferably, rotary drives 54, 56, 58, 60 have high and low geared speeds such that in low gear very high torque is produced with a very low rotational speed. In high gear, much less torque is produced but the rotational speed is quite high so that spinning operation takes place rapidly. However, if desired, separate drives, such as drive 38 in accord with the present invention, could be specifically designed for spinning and for torqueing although having one rotary drive to perform both functions is presently considered more efficient.

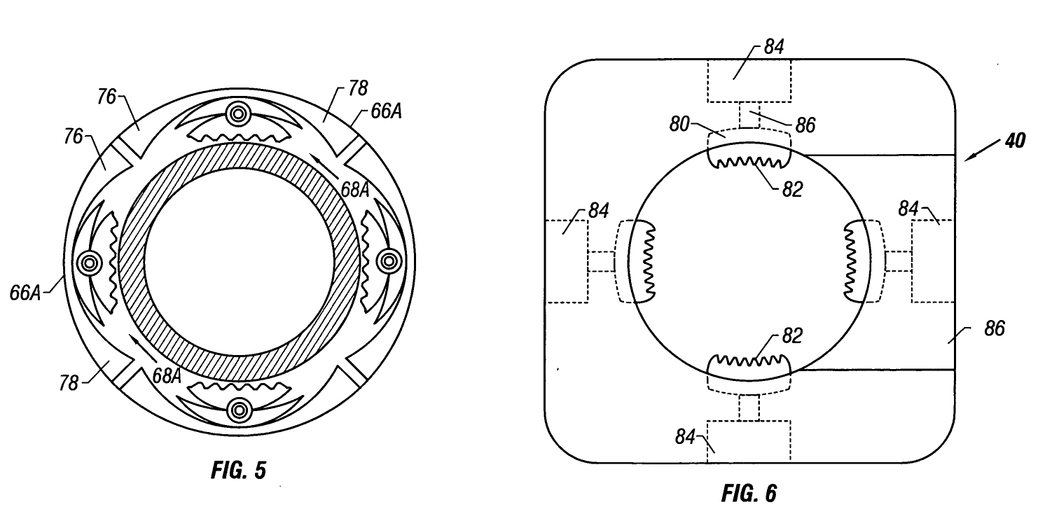

For simplicity, FIG. 4 shows only a system for operating in one rotational direction. While a single direction rotary drive be used for both tightening or loosening, for instance by inverting rotary drive 38 or cams 60 or slips 68 when desired, preferably rotary drive 38 operates in two directions. For instance, FIG. 5 shows cams 66A each having two lobes 76 and 78 for wedging bi-directional slip assemblies 68A outwardly for gripping engagement with pipe string 18 regardless of the direction of rotation. Other cam/slip arrangements could also be used, which may involve inverting cams, utilizing pins as stop members, and the like. Thus, rotary drive 38 is preferably constructed so as to apply rotational force in both directions to permit rotary drive 38 to either make or break connections within pipe string 18.

FIG. 6 discloses a representative example of backup tong 40 although backup tong 40 may be constructed in various ways. Backup tong 40 may be used to provide a backup to rotary drive 38 for purposes of making and breaking connections within pipe string 18. Thus, backup tong 40 holds one pipe stationary while rotary drive tong 38 rotates another pipe to thereby either make or break the respective connection. In one embodiment, backup tong 40 has a plurality of slips 80 with teeth 82. Slips 80 may be moved radially inwardly and radially outwardly using actuators 84 which operate drive shafts 86. Actuators 84 are mounted within power tong housing 36 which may be same or a separate housing from that used for rotary drive 38. Actuators 84 may be operated by hydraulic force, pneumatic force, or other means as desired. Preferably, an opening may be provided in power tong housing 36 by removing section 86 so that power tong system 10 may be moved laterally with respect to pipe string 18, if desired. Thus, any hydraulic cables or pneumatic cables preferably enter only one side of section 86 and are flexible so that section 86 can be removed with any cables laid on one side as desired.

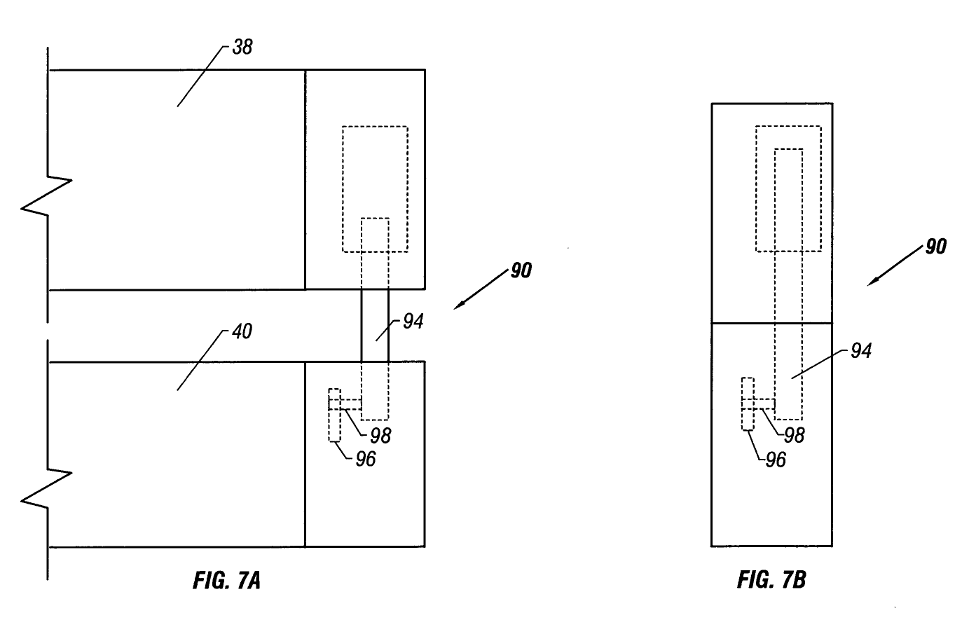

As rotary drive tong 38 rotates one pipe while backup tong 40 holds the other pipe stationary, relative axial movement occurs between tong 38 and tong 40 due to the threads making up or breaking. Referring to FIG. 7A and FIG. 7B, a slip connection, such as slip connection 90, is preferably provided therebetween to accommodate this motion. Although slip connection 90 may be of many constructions to accommodate relative axial motion of rotary tong 38 relative to backup tong 40, a representative construction is shown in FIG. 7A and FIG. 7B. FIG. 7A shows connection 90 in an extended position and FIG. 7B shows connection 90 in a retracted or compressed position. Thus, actuator 92 may be used to compress or extend connection 90 with shaft 94, depending on whether the connection is to be broken or made to the lengths of either end of slot 96 as controlled by pin 98. Relative sliding movement of shaft 94 then occurs with respect to slot 96 as the connection is made or broken. Pins or other means (not shown) may be provided to adjust the amount of slip to a preset amount depending on the type of pipe or connection.

In FIG. 8, power tong system 10 is arranged for engaging upper pipe 100 and lower pipe 102 above and below joint 104, as may be desired when connecting joints of casing. In this embodiment, an extra length of shaft 106 may be inserted between rotary drive tong 38 and backup tong 40. Moreover, due to significant variation permitted in the location of rotary drive tong 38 and backup tong 40, it may not be necessary to change the relative positions for each connection to be made up.

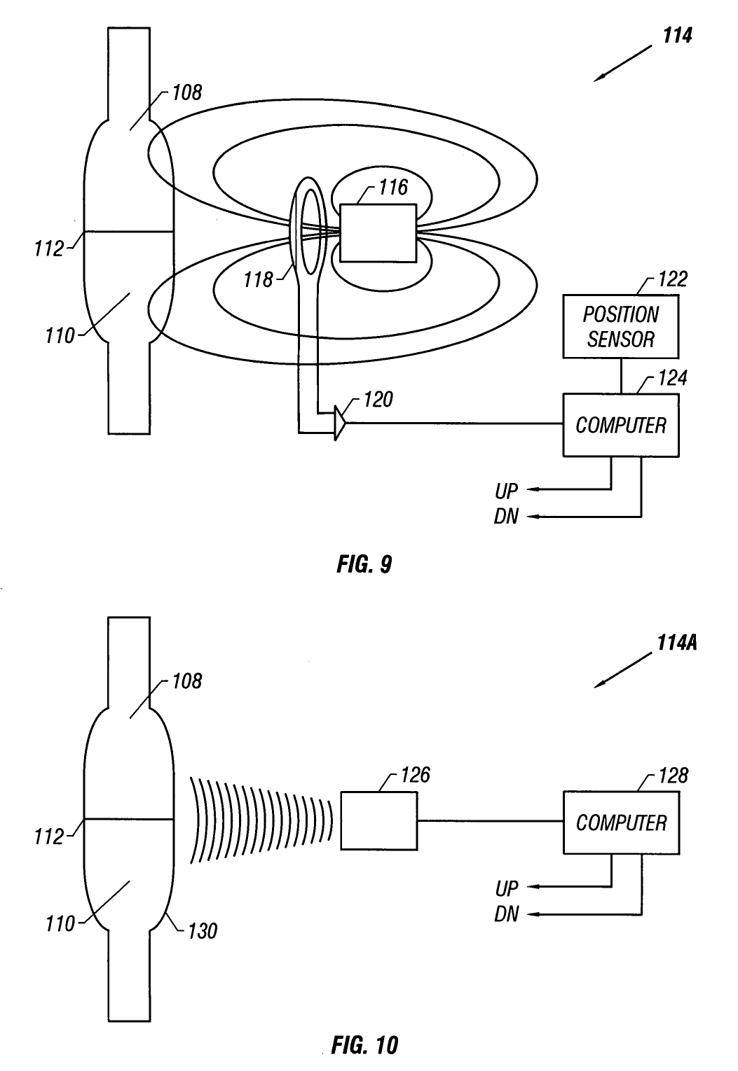

However, for the situation where it is necessary that rotary drive tong 38 and backup tong 40 be positioned on the enlarged or upset portions of a connection, such as shown in FIG. 3, in one preferred embodiment of the present invention means are provided for automatic axial or up and down positioning. For this purpose, the present invention preferably utilizes a collar locator. Various designs of collar locators may be used in the present invention. For instance, in FIG. 9, a connection 112 with upper portion 108 and lower portion 110 are detected as magnetic flux changes occur when collar detector 114 is passed by connection 112. Magnetic flux is produced by magnet 116 and, due to the increased metal mass of connection 112, changes when rotary drive housing 36 moves by connection 112 due to axial motion created by lift assemblies 41. The magnetic flux changes are detected by wire loop 118 which are amplified by amplifier 120 with signal versus position computed in processor 124. The axial position of power tong housing 36 may be detected by numerous different types of sensors such as sensor 122. Processor 124 then provides an up/down signal for lift assembly 41 to thereby automatically position tong housing 36 appropriately with respect to connection 112.

The same magnetic flux detector used for locating a collar, or an analogous type of detector can be used to detect a decrease in the metal of a tubular, and thus detect cracks, holes, leaks or other anomalies in the tubular being made up or broken out of the oil well tubular string. Using techniques well known in the electronic art, the collar locator and the anomaly detector can be the same detector using time share or time multiplexing, or the like, or can involve the use of separate devices for the two functions.

FIG. 10 shows an alternate embodiment collar detector 114A with a transmitter/receiver 126. It will be understood that transmitter/receiver 114A may comprise one or more transmitters and/or receivers. Means may be provided for detecting a distance between outline 130 of connection 112 and transmitter/receiver 126. For instance, acoustic pulses may be transmitted and received with the time interval measured. As the time interval decreases when detector 114A moves by joint 112, computer 128 will then control the position of power tong housing 36 by similar means as described in connection with collar locator 114. Although the collar locators of FIG. 9 and FIG. 10 are both effectively proximity detectors that effectively detect proximity of the pipe to the sensor, other proximity detectors and/or other designs for collar locators could also be used. Collar locator 114 or 114A could be positioned as desired with respect to power tong system 10. For instance, the collar locator could be positioned within or adjacent rotary drive housing 36.

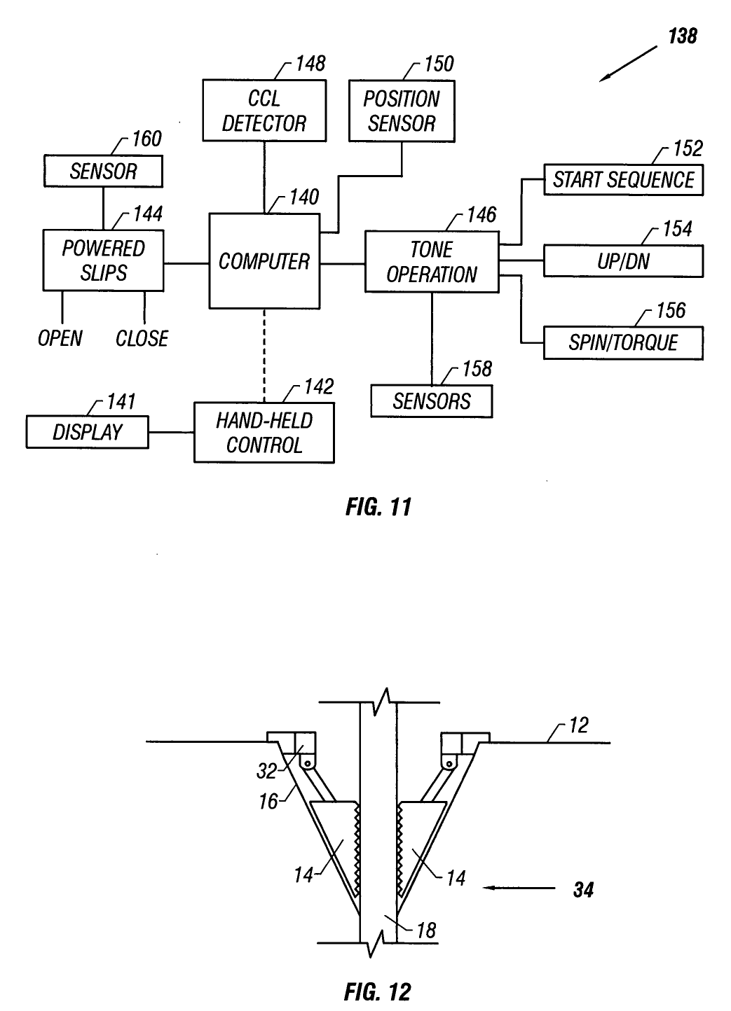

FIG. 11 provides overall control system 138 for the power tong system 10 of present invention. Thus, computer 140, having a visual display device 141, for example, a conventional CRT device, may be used to control overall operation. An input device, which may be any input device including hand-held control 142 may be used to receive operator input. Computer 140 coordinates operation of powered slips 144 with power tongs 146. Collar locator information is received from collar locator module 148 and the axial position or distance from rig floor 12 is provided by position sensor 150. Tong operating sequence may be started and include automatic positioning of the tong housing as per sequence control module 152, and may include issuing up or down signals from module 154, as well as controlling torque such as by high speed and low speed signals from module 156. Numerous sensors may be used. For instance, torque sensors or other sensors from module 158 may be used to control the amount of torque applied to the connection and/or switch from spinning mode to torque mode. Sensors 160 may be used to detect the status of powered slips 160 to verify operation in response of commands to grip or release (close or open) the slips. It will be understood that the general architecture and structure of control system 138 can be quite varied with the above system be one representative system.

In summary, power tong system of the present invention preferably provides a wrap-around tong for performing all operations of making and breaking joints including spinning and torqueing joint connections without the need for lateral movement with respect to pipe string 18. Preferably powered slips, such as representative powered slips 34, are used as part of the system. Moreover, preferably a collar locator and processing means are provided for automatic positioning of the rotary drive tong 38 and backup tong 40 in accord with the present invention.

Numerous variations of the above system and method are possible, some of which have already been described. Therefore, it will be understood that many additional changes in the details, materials, steps and arrangement of parts, may be made by those skilled in the art within the principle and scope of the invention as expressed in the appended claims.

1. A power tong system for applying torque to a plurality of connections in a tubular string, said power tong system being operable on a rig floor, said power tong system comprising:
a power tong housing;
at least one rotary drive tong mounted within said power tong housing for encircling and for applying rotational force to a first portion of said tubular string;
at least one backup tong, said backup tong having gripping elements therein for holding a second portion of said tubular string while said at least one rotary drive tong applies said rotational force to said first portion of said tubular string; and
a plurality of moveable shafts moveable substantially parallel to said tubular string for moving said power tong housing upwardly and downwardly, said moveable shafts being mounted with respect to said rig floor such that said power tong housing is moveable upwardly and downwardly with respect to said rig floor and wherein the plurality of moveable shafts prevent said power tong housing from rotating and moving laterally with respect to said rig floor for applying torque to said plurality of connections;
a collar locator for producing a collar locator signal in response to at least one of said connections in said tubular string, and
a control responsive to said collar locator signal for automatically controlling said upwardly or downwardly movement of said power tong housing for positioning said at least one rotary drive tong and said at least one backup tong with respect to said at least one of said connections.

2. The power tong system of claim 1, further comprising:
powered slips operable for powered movement of slips into and out of gripping engagement with said tubular string, said powered slips being operable for supporting a weight of said tubular string.

3. The power tong system of claim 1, further comprising:
a drive gear within said at least one rotary drive tong which completely encircles said tubular string.

4. The power tong system of claim 3, further comprising:
a plurality of cams mounted to said drive gear for movement therewith.

5. The power tong system of claim 3, further comprising:
a rotatable gear within said at least one rotary drive tong, and
a removable section for said drive gear, said removable section being removable such that said drive gear can be laterally moved away from said tubular string.

6. The power tong system of claim 1, further comprising:
an expandable connection between said at least one rotary drive tong and said at least one backup tong to permit relative up and down movement therebetween.

7. The power tong system of claim 1, further comprising:
an extension member for connecting between said at least one rotary drive tong and said at least one backup tong to permit said at least one rotary drive tong and said at least one backup tong to both grip either on a respective portion of said connection or simultaneously above and below said connection.

8. The power tong system of claim 1, further comprising:
a plurality of piston driven gripping elements within said at least one backup tong for selectively engaging and disengaging said second portion of said tubular string.

9. A power tong system for operating on connections in a tubular string, said power tong system being operable on a rig floor, said power tong system comprising:
at least one rotary drive tong for gripping a first portion of said tubular string, said at least one rotary drive tong having a rotatable gear therein for applying rotational force to said first portion of said tubular string;
at least one backup tong, said backup tong having gripping elements therein for holding a second portion of said tubular string while said at least one rotary drive tong applies said rotational force to said first portion of said tubular string;
a one or more lift assemblies for moving said at least one rotary drive tong upwardly and downwardly, said one or more lift assemblies being secured with respect to said rig floor such that said at least one rotary drive tong is moveable upwardly and downwardly with respect to said rig floor, wherein said one or more lift assemblies prevent said power tong system from rotating and moving laterally with respect to said rig floor;
powered slips operable for powered movement of slips into and out of gripping engagement with said tubular string, said powered slips being operable for supporting a weight of said tubular string;
a collar locator for producing a collar locator signal in response to at least one of said connections in said tubular string; and
a control responsive to said collar locator signal for automatically controlling said upwardly or downwardly movement of said one or more lift assemblies.

10. The power tong system of claim 9, further comprising:
an electronic proximity detector for said collar locator.

11. The power tong system of claim 10, wherein said collar locator further comprises:
circuitry for detecting variations in a magnetic field.

12. The power tong system of claim 10, wherein said collar locator further comprises:
circuitry for detecting variations in a transmitted signal.

13. The power tong system of claim 9, further comprising:
a power tong housing for said at least one rotary drive tong, said power tong housing being supported by said lift members for movement upwardly and downward, said lift members preventing rotational movement of said power tong housing.

14. The power tong system of claim 9, further comprising:
a drive gear within said at least one rotary drive tong which completely encircles said tubular string.

15. The assembly of claim 14, further comprising:
a removable section for said drive gear, said removable section being removable such that said drive gear can be laterally moved away from said tubular string.

16. A method for operating on a plurality of connections in a tubular string as said tubular string is run into or out of a wellbore, said method comprising:
providing a power tong housing with a rotatable drive gear therein such that said power tong housing remains encircling said tubular string as said tubular string is run into or out of said wellbore;
securing a back up power tong with respect to said power tong housing;
moving said power tong housing and said back up power tong in a direction substantially parallel with respect to said tubular string;
supporting said power tong housing to a rig floor to prevent lateral movement and rotational movement of said power tong housing during said operating on said plurality of connections; and
producing an electronic signal in response to locating a connection, and
positioning said rotary drive tong and said power tong backup in response with respect to said tubular string in response to said electronic signal.

17. The method of claim 16, wherein said rotatable drive gear comprises a removable section.

18. The method of claim 16, further comprising:
supporting said tubular string with powered slips.

19. A power tong system for applying torque to a plurality of connections in a tubular string, said power tong system being operable on a rig floor, said power tong system comprising:
a power tong housing;
at least one rotary drive tong mounted within said rotary drive tong housing for encircling and for applying rotational force to a first portion of said tubular string;
at least one backup tong, said backup tong having gripping elements therein for holding a second portion of said tubular string while said at least one rotary drive tong applies said rotational force to said first portion of said tubular string; and
a plurality of moveable shafts moveable substantially parallel to said tubular string for moving said power tong housing upwardly and downwardly, said moveable shafts being mounted with respect to said rig floor such that said power tong housing is moveable upwardly and downwardly with respect to said rig floor and wherein the plurality of moveable shafts prevent said power tong housing from rotating and moving laterally with respect to said rig floor for applying torque to said plurality of connections;
a sensor for producing a signal indicative of cracks or holes in at least one of said tubulars in said tubular string and
for producing a collar locator signal in response to at least one of said connections in said tubular string, and
a control responsive to said collar locator signal for automatically controlling said upwardly or downwardly movement of said power tong housing for positioning said at least one rotary drive tong and said at least one backup tong with respect to said at least one of said connections.

20. A power tong system for operating on connections in a tubular string, said power tong system being operable on a rig floor, said power tong system comprising:
at least one rotary drive tong for gripping a first portion of said tubular string, said at least one rotary drive tong having a rotatable gear therein for applying rotational force to said first portion of said tubular string;
at least one backup tong, said backup tong having gripping elements therein for holding a second portion of said tubular string while said at least one rotary drive tong applies said rotational force to said first portion of said tubular string;
a one or more lift assemblies for moving said at least one rotary drive tong upwardly and downwardly, said one or more lift assemblies being secured with respect to said rig floor such that said at least one rotary drive tong is moveable upwardly and downwardly with respect to said rig floor, wherein said one or more lift assemblies prevent said power tong system from rotating and moving laterally with respect to said rig floor;
powered slips operable for powered movement of slips into and out of gripping engagement with said tubular string, said powered slips being operable for supporting a weight of said tubular string;
a sensor for producing a collar locator signal in response to at least one of said connections in said tubular string and for producing a signal indicative of cracks or holes in at least one of said tubulars in said tubular string; and
a control responsive to said collar locator signal for automatically controlling said upwardly or downwardly movement of said one or more lift assemblies.

21. A method for operating on a plurality of connections in a tubular string as said tubular string is run into or out of a wellbore, said method comprising:
providing a power tong housing with a rotatable drive gear therein such that said power tong housing remains encircling said tubular string as said tubular string is run into or out of said wellbore;
securing a back up power tong with respect to said power tong housing;
moving said power tong housing and said back up power tong in a direction substantially parallel with respect to said tubular string;
supporting said power tong housing to a rig floor to prevent lateral movement and rotational movement of said power tong housing during said operating on said plurality of connections; and
positioning said rotary drive tong and said power tong backup.

22. A power tong system for operating on connections in a tubular string, said power tong system being operable on a rig floor, said power tong system comprising:
at least one rotary drive tong for gripping a first portion of said tubular string, said at least one rotary drive tong having a rotatable gear therein for applying rotational force to said first portion of said tubular string;
at least one backup tong, said backup tong having gripping elements therein for holding a second portion of said tubular string while said at least one rotary drive tong applies said rotational force to said first portion of said tubular string; and
a one or more lift assemblies for moving said at least one rotary drive tong upwardly and downwardly, said one or more lift assemblies being secured with respect to said rig floor such that said at least one rotary drive tong is moveable upwardly and downwardly with respect to said rig floor, wherein said one or more lift assemblies prevent said power tong system from rotating and moving laterally with respect to said rig floor.

23. The power tong system for operating on connections in a tubular string of claim 22 further comprising powered slips operable for powered movement of slips into and out of gripping engagement with said tubular string, said powered slips being operable for supporting a weight of said tubular string.

24. The power tong system for operating on connections in a tubular string of claim 22 further comprising a collar locator for producing a collar locator signal in response to at least one of said connections in said tubular string.

25. The power tong system for operating on connections in a tubular string of claim 24 further comprising a control responsive to said collar locator signal for automatically controlling said upwardly or downwardly movement of said one or more lift assemblies.
